(19) United States
(12) Patent Application Publication
(10) Pub. No.: US 2022/0299750 A1
(43) Pub. Date: Sep. 22, 2022

(54) WATCHMAKER'S LOUPE

(71) Applicant: ROLEX SA, Geneve (CH)

(72) Inventors: Robin Brandt, Geneve (CH); Marc Cerutti, Geneve (CH); Olivier Thèobald, Geneve (CH)

(73) Assignee: ROLEX SA, Geneve (CH)

(21) Appl. No.: 17/695,384

(22) Filed: Mar. 15, 2022

(30) Foreign Application Priority Data
Mar. 16, 2021 (EP) 21162999.3

(51) Int. Cl. G02B 25/00; G02B 27/01

(52) U.S. Cl. CPC G02B 25/001; G02B 25/007; G02B 27/0172; G02B 2027/0178

(57) ABSTRACT

An optical device including a first optical axis; an optical device body, notably a substantially cylindrical body; and a capture device for capturing at least a portion of the images seen by the user through the optical device; the optical device being a monocular watchmaker's loupe that can be positioned or worn in front of or close to a user's eye.

This application claims priority of European Patent Application No. EP21162999.3, filed on Mar. 16, 2021, the contents of which is hereby incorporated by reference herein in its entirety.

The invention relates to an optical device, notably a watchmaker's loupe. The invention also relates to a portable system including such an optical device.

### BACKGROUND ART

The watchmaker's loupe is the main optical device used by a watchmaker. Indeed, the properties of this small, lightweight magnification device make it particularly ergonomic and useful for examining and working on small components, such as those found in a watch or a clockwork movement.

However, this tool does not enable the watchmaker to share their vision axis with third persons to show specific details, such as an assembly, adjustment, lubrication or wear. To do so, double binocular magnifiers fitted with a camera to share the watchmaker's view are currently used. However, such binocular magnifiers are relatively large and the space available beneath the lens is very limited, which considerably reduces the working space about the object being observed. Furthermore, such binocular magnifiers are static and require the watchmaker to orient the watch or movement beneath the lens, which is often impossible with certain operations that require the watch or movement to be stabilized and flat on a workbench. Such tools do not afford the watchmaker with the full freedom required to undertake certain operations, as with a loupe. Furthermore, some operations are very difficult or impossible to perform and show correctly beneath a binocular magnifier. It is essential for watchmakers to be able to share certain problems and their knowhow in an optimal manner.

A device arranged on a headband that is particularly suited to surgeons and that is used to illuminate a working zone and to send images of said working zone to an attached screen is known from document FR2368929.

A magnification device designed for precision medical and mechanical applications is known from document DE4436528. This device is provided with a camera arranged on a support similar to a pair of glasses, with a lens oriented in a direction substantially parallel and beside the vision axis of the user. The camera enables the user to broadcast, notably using a screen, a magnified view in the lower zone of their field of vision. The user has a simultaneous direct view in the upper zone of their field of vision.

### SUMMARY OF THE INVENTION

The purpose of the invention is to provide an optical device to overcome the drawbacks mentioned above and to improve the optical devices known in the prior art. In particular, the invention proposes a compact, portable optical device that enables the field of vision of a watchmaker to be recorded and/or shared.

An optical device according to the invention is defined in claim 1.

Different embodiments of the optical device are defined in claims 2 to 14.

A portable system according to the invention is defined in claim 15.

An embodiment of the portable system is defined in claim 16.

### BRIEF DESCRIPTION OF THE DRAWINGS

The attached drawings show two example embodiments of a portable system according to the invention.

FIG. 1 is a perspective view of a first embodiment of a portable system.

FIG. 2 is an exploded perspective view of the first embodiment of the portable system.

FIG. 3 is a perspective view of the first embodiment of the portable system (similar to the view in FIG. 1) including an optical system with dropped lens.

FIG. 4 is a partial longitudinal cross-section view of the first embodiment of the portable system with a first embodiment of an optical device.

FIG. 5 is a partial longitudinal cross-section view of a variant of the first embodiment of the optical device.

FIG. 6 is a perspective view of the first embodiment of the portable system (similar to the view in FIG. 1) with an optical device in retracted position.

FIG. 7 is a partial longitudinal cross-section view of a second embodiment of the portable system with a second embodiment of the optical device.

FIG. 8 is an electronic diagram showing the embodiments of the optical device.

### DETAILED DESCRIPTION OF PARTICULAR EMBODIMENTS

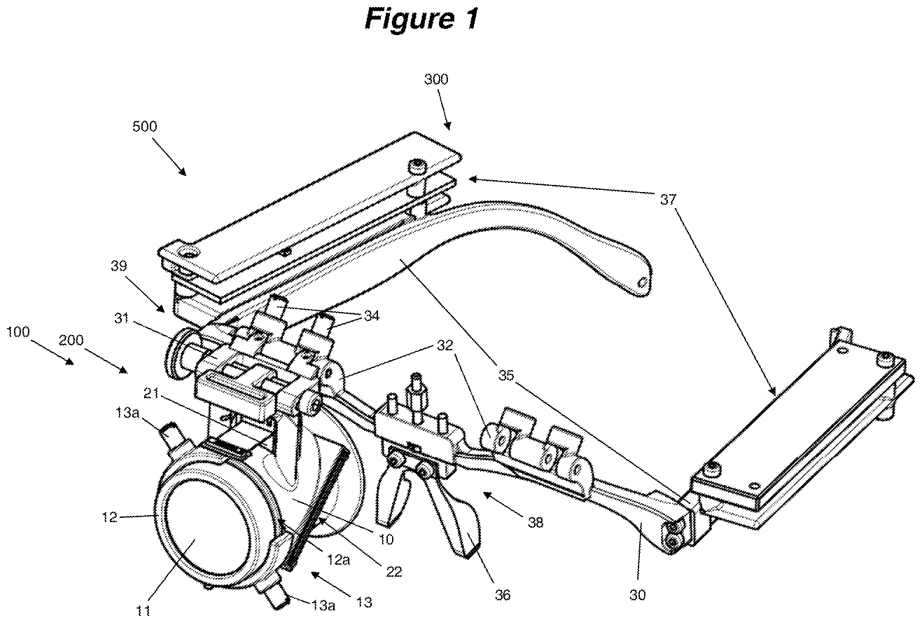

A first embodiment of a portable system 500 is described below with reference to FIGS. 1 to 6.

The portable system 500 includes a first embodiment of an optical device 100 and a support 300, notably eyeglass frames 300, on which the optical device 100, in particular a body 10 of the optical device, is mounted.

In a variant, the support can be a headset or a headband.

Advantageously, the portable device 500, and more specifically the support 300, includes:
an adjustment element 38, 39 arranged such as to position the optical device 100 relative to the user's eye, and/or
a fastening assembly 31, 32 arranged such as to enable the optical device 100 to be removed from the user's eye or to be retracted.

This adjustment element and this fastening assembly are described in greater detail below.

The optical device 100 is designed to be positioned or worn or carried in front of or close to a user's eye. The optical device includes:
a first optical axis A1,
an optical device body 10, notably a substantially cylindrical body, and
a capture device 200 for capturing at least a portion of the images seen by the user through the optical device.

The optical device is preferably a magnifying optical device or a watchmaker's loupe. In particular, the optical device is advantageously a monocular loupe.

The capture device 200 can include a video or photographic sensor 21. The sensor 21 is preferably a high-definition micro camera. The sensor 21 may be fitted with an autofocus system.

In order to provide captured images with greater magnification than the images transmitted to the user's eye, the sensor 21 may also be fitted with an optical and/or digital magnification system.

Advantageously, the sensor 21 can also be fitted with an optical and/or digital image stabilization system. The image stabilization system notably enables any shaking suffered by the optical device 100 to be filtered out.

The sensor 21 can also have a horizontal image stabilization system. The horizontal image stabilization system enables the image to be kept horizontal regardless of the orientation of the optical device 100.

More generally, the sensor 21 can naturally be provided with any means for improving the quality of the images or videos captured.

At a given instant, the capture device 200 can capture at least a portion of what the user can see in their field of vision through the optical device. It is naturally possible that, at said given instant, the capture device 200 can capture everything that the user can see in their field of vision through the optical device, or more than the user can see in their field of vision through the optical device. Furthermore, the capture can be effected continuously over time. Nonetheless, captures may be taken at given instants only, for example as photographs, or for certain defined periods of time.

Since the capture device 200 can capture at least a portion of the images seen by the user through the optical device, the point of view of the user and the point of view of the capture device is identical or nearly identical. In other words, the parallax between what the user sees and what is captured by the capture device 200 is zero or minimized as much as possible. Preferably, the coaxiality defect between the first optical axis A1 of the optical device and the optical axis of the user is less than 0.2 mm, or less than 0.1 mm.

In order to simplify the description, the first optical axis A1 of the optical device coincides in this case with the vision axis or optical axis of the user. In other words, this axis A1 represents the orientation of the view of the user through the optical device 100.

This first embodiment has the advantage of providing the user with a direct view through the optical device 100, without the user being disturbed by the capture device.

The body 10 of the optical device 100 is a tube that is partially hollow and flared at a first extremity designed to be positioned close to the user's eye, notably to fit into the user's eye socket. The body is preferably designed to support an optical system 11 at a second extremity thereof.

The diameter and/or shape of the first extremity of the body 10 are preferably designed to enable the user to seat the optical device 100 in their eye socket in the manner of a conventional watchmaker's loupe.

The axis of revolution of the body 10 is coaxial or substantially coaxial with the axis A1.

The capture device 200 is arranged inside the optical device 100. This capture device 200 includes the sensor 21, preferably arranged to film or capture one or more images along or substantially along the axis A1. The sensor 21 advantageously enables a light radiation incident thereon to be converted into a set of digital data used to define an image determined by the light radiation.

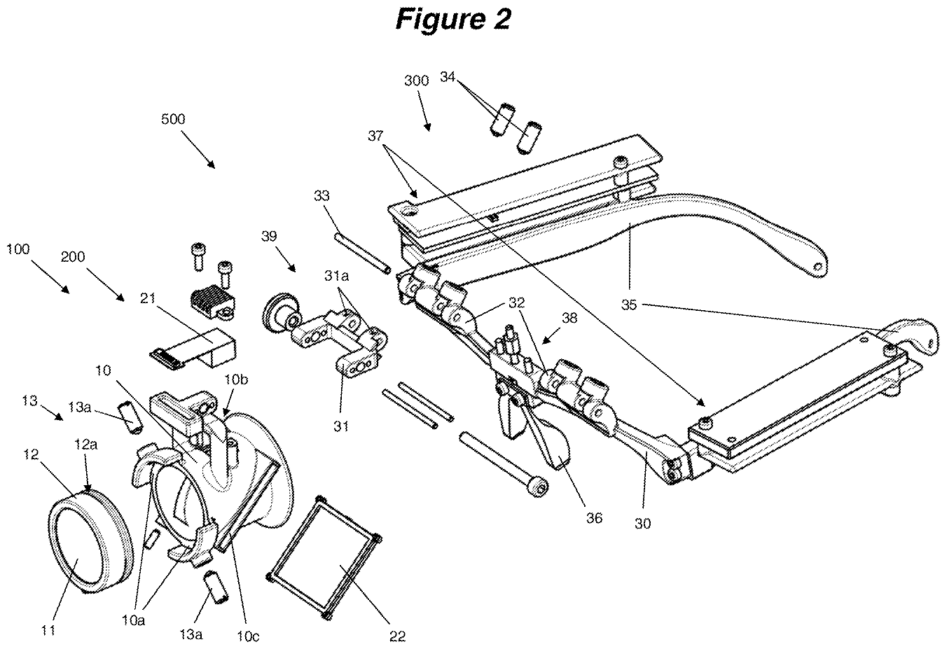

In the first embodiment of the optical device 100, this sensor 21 is preferably arranged on the outer periphery of the body 10 in a seat 10b (shown in FIG. 2), outside the field of vision of the user. The sensor 21 is arranged so as not to hinder the user's operations on the object being observed through the optical device 100. In other words, the user must be able to use tools and to get sufficiently close to the object, while freely orienting the object within the vision axis A1 without being hindered by the optical device 100. Consequently, the sensor 21 is preferably arranged above the body 10 and opposite the workbench or work space of the user, and fits into a longitudinal space along the axis A1 of the body 10. This longitudinal space, measured from the first extremity to the second extremity of the body 10, is for example in the order of a few centimeters, in particular in the order of 4 cm (measured parallel to the optical axis A1).

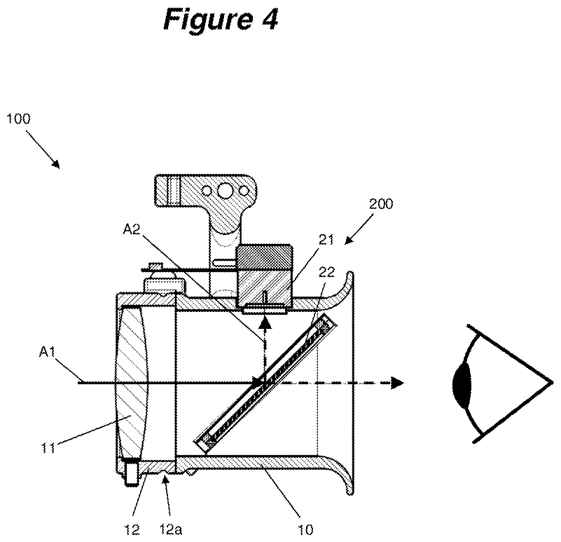

Furthermore, as shown in FIG. 4, the capture axis of the sensor 21 is preferably oriented perpendicular to the vision axis A1 along an axis A2.

Preferably, the optical device 100 is designed so that it is easy to identify the position of the sensor 21 in space, so that the sensor is always positioned upwards by the user. For example, the optical device 100 and/or the portable device 500 can have a key preventing the user from orienting the optical device with the sensor 21 beneath the body 10 (when the optical device is configured for use by the user).

Given that the sensor 21 is oriented along the axis A2, which is preferably perpendicular to the vision axis A1, a portion of the light captured by the optical device 100 has to be diverted towards the sensor 21. To do so, the optical device 100 includes a semi-transparent mirror 22 arranged inside the body 10. The semi-transparent mirror 22 enables a first portion of the light coming from the observed object or scene to be reflected and propagated globally along the axis A1 towards the sensor 21 along the axis A2. Advantageously, a second portion of the light is not reflected and passes through the semi-transparent mirror along the axis A1 so that the user can see the observed object or scene through said semi-transparent mirror.

Advantageously, the arrangement of the semi-transparent mirror 22 inside the optical device 100 enables the sensor to capture images from the same or substantially the same vision axis A1 as the user.

The semi-transparent mirror 22 is preferably arranged in a seat 10c made in the body 10 (as shown in FIG. 2). This seat 10c is in this case an inclined slot (notably inclined to 45°) in relation to axis A1. This slot enables insertion of the semi-transparent mirror 22. The semi-transparent mirror 22 can be held in place in this seat 10c, notably using a screw.

It should be noted that the images captured by the sensor are inverted by the semi-transparent mirror. These images can be corrected (i.e. inverted back) using digital processing.

The outer shape of the semi-transparent mirror 22 is square in the variant embodiment shown. Alternatively, the outer shape of the semi-transparent mirror and of the seat designed to receive said mirror may be different. A circular or elliptical semi-transparent mirror may be used, for example. The semi-transparent mirror can be assembled with the body at one of the extremities of the body. The semi-transparent mirror can also be snap-fitted, driven or glued in the seat 10c.

The seat 10c notably enables the semi-transparent mirror to be oriented at a predetermined angle relative to the axis A1.

In a specific variant embodiment shown in FIGS. 1 to 5, the angle measured between the axis A1 and the axis A2 is 90°. Consequently, the semi-transparent mirror is in this case arranged at an angle of 45° in relation to the axis A1 and in relation to the axis A2 of the sensor.

Alternatively, the axis A2 of the sensor need not be perpendicular to the axis A1, but parallel and not coaxial, for example. With this new orientation of the axis A2, an additional mirror is then required to divert the light already diverted by the semi-transparent mirror. Alternatively, the axis A2 can form a non-zero angle and different from 90° with the axis A1.

The semi-transparent mirror 22 is for example designed to divert 50% of the light incident thereupon towards the sensor 21. In this example, 50% of the light is not diverted and reaches the user's eye.

Alternatively, the semi-transparent mirror can divert a different proportion of the light towards the sensor 21. This proportion can vary between 10% and 90% as a function of the sensitivity of the sensor and/or as a function of the desired proportion of the light to be directed towards the user's eye.

Thus, the semi-transparent mirror 22 is arranged inside the body 10 such as to:
divert a first portion of the light rays entering the optical device 100 towards the sensor 21, and
allow a second portion of the light rays entering the optical device 100 to pass through said mirror to the user's eye.

More generally, the semi-transparent mirror can be any optical component enabling beam splitting.

The sensor 21 is designed to capture images or videos. These images, in data form, can then be sent to be broadcast in real time or with a slight delay, or to be processed. This enables third persons to use an attached screen to see what the user is seeing through the optical device 100 along the vision axis A1. Naturally, the videos and images captured by the sensor can also be saved and viewed later.

To do so, the optical device 100 includes a communication element 50 that is designed to send data generated by the capture device 200 and/or to send data to the capture device 200.

For example, the sensor 21 sends and receives data over a USB cable. Preferably, in order to lighten the optical device 100 as much as possible, the electronic module required to operate the sensor is not arranged on the optical device 100, but is remote. For the same purpose, data storage is provided for in an attached peripheral, such as a computer for example.

However, in consideration of technological advances in electronic components and more specifically the miniaturization of micro-sensors fitted to micro-cameras for example, it is entirely feasible to arranged such a sensor or such a high-definition camera able to store or send the captured data wirelessly and in real time, for example using a Wi-Fi protocol. The sensor may also include a miniature battery to obviate the need for a power cable.

For this purpose, the optical device may include a first induction charging element to recharge the battery. Between two uses, the user can then place the optical device on a support with a second induction charging element to recharge the battery of the device.

The optical device 100 preferably includes an optical system 11 including one or more lenses 11, in particular a lend 11 held on the body 10 by retaining means 13.

The retaining means 13 are friction, snap-fit or obstacle retaining means, notably retaining means 13 arranged such as to enable an optical system 11 to be positioned and/or mounted without using tools.

The optical system 11 for example includes one or more lenses 11, or comprises for example one or more lenses 11. The optical system 11 can include a biconvex lens arranged perpendicularly or substantially perpendicularly to the axis A1. Alternatively, the lens 11 can also for example be a plano-convex lens.

Naturally, the size of this optical system 11 and the position thereof in relation to the user's eye along the axis A1 is carefully predetermined such as to provide an optical device offering a field of vision and a degree of magnification that are suited to the user's requirements.

Advantageously, the optical system 11 is arranged inside a preferably cylindrical ring 12. This ring 12 enables the optical system 11 to be centered on the body 10 of the optical device 100. More specifically, the geometry of the body 10 is notably designed to enable the optical system 11 to be centered using the ring 12. Preferably, the optical system 11 is centered on the axis A1.

For example, the optical system 11 is clamped in the ring 12 by a screw. Alternatively, the optical system 11 can be assembled on the ring by any other means enabling the rigid connection therebetween. The optical system 11 can also be integral with the ring 12. Alternatively, the optical system 11 can be assembled directly on the body 10 and therefore be rigidly connected to the body 10.

As shown in FIGS. 1, 2 and 3, the second extremity of the body 10 shows a seat 10a designed to receive the optical system 11, and more specifically the ring 12. This seat 10a includes two cylindrical portions that are concentric with the axis A1, with internal diameters that are designed to fit on the external diameter of the ring 12. Furthermore, the seat 10a is also provided with an axial stop along the axis A1 that guarantees a predetermined distance between the optical system 11 and the second extremity of the body 10, and more specifically the user's eye.

The optical system 11 is held assembled on the body 10 by retaining means 13 designed to cooperate with the ring 12. More specifically, the retaining means 13 are spring plungers or ball plungers 13a that are designed to cooperate with a groove 12a in the ring 12.

The groove 12a is arranged about the circumference of the ring 12 and in this case has a V-shaped section.

Each of the ball plungers 13a is a grub screw containing a ball pushed by a spring towards one of the extremities thereof and a slot designed to cooperate with a screwdriver at the other extremity thereof.

The two ball plungers 13a are for example arranged radially in relation to the axis A1 about the periphery of the first seat 10a. More specifically, these plungers are installed in threaded holes in the body 10 such as to enable the ball therein to cooperate with the groove 12a in the ring. In addition to being centered by the seat 10a, the optical system 11 is therefore also held axially in position by the shape of the groove 12a and the ball of the ball plungers 13a.

Each of the return springs of the ball plungers 13a enables the respective ball to be held against the groove 12a of the ring 12 such as to exert a holding force on said ring. These components are dimensioned to guarantee a suitable hold of the optical system 11 on the body 10 in order to obviate all risk of said components becoming detached accidentally under normal operating conditions.

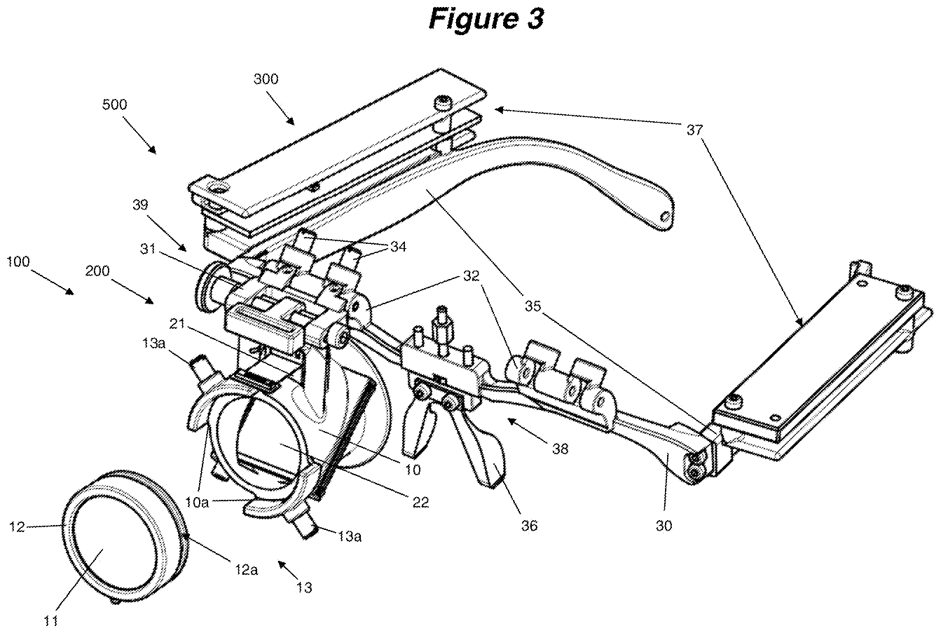

Advantageously, the elements of the retaining means 13 are also dimensioned to enable the user to easily interchange the optical system 11 of the optical device 100 (as shown in FIG. 3). More specifically, the axial force along the axis A1 required from the user to retract the ball of the ball plungers 13a to disconnect the optical system 11 from the body 10 must be low enough to enable the operation to be performed rapidly and without tools, and even without having to remove the optical device 100 from the vision axis of the watchmaker.

The friction generated by each of the ball plungers can be adjusted by adjusting the pre-stressing of the return springs of the ball plungers. To do so, the ball plungers 13a need simply be screwed or unscrewed, for example using a screwdriver on the screw head of said plungers.

Alternatively, the ball plungers can be replaced by springs in the form of blades or an elastic ring concentric with the groove cooperating with said ring.

Alternatively, the optical system 11, with or without the ring 12, can simply be snap-fitted or lightly driven, with or without an elastic element, such as an elastic ring or an O-ring, for example.

Alternatively, the optical system 11, and more specifically the ring 12, can also be held on the body by a bayonet system, or screwed directly onto the body.

More generally, the retaining means 13 can be any means enabling the optical system 11 to be held on the body 10 by friction, snap-fitting or clamping that enable the user to disconnect said means without using any tools.

The retaining means 13 advantageously enable the user to easily interchange the optical system 11 of the optical device 100 as required, as the user would with conventional watchmaker's loupes to obtain different degrees of magnification.

The typical magnifications obtained using the optical systems 11 that can be used are 2.5× to 25×.

The optical systems 11 and/or the rings 12 can for example have different colors or markings to indicate the different degrees of magnification of the device.

Alternatively or complementarily, the optical systems 11 can also include optical filters, for example providing a better view of manufacturing defects, component wear, lubricants or specific components. These optical filters can be combined with specific lighting to highlight specific materials or substances for the purpose of identification or checking.

Advantageously, the optical device includes a projection element 40, 41 for projecting visual data visible by the user by displaying on a screen that is part of the optical device and/or by projecting light rays towards the user's eye.

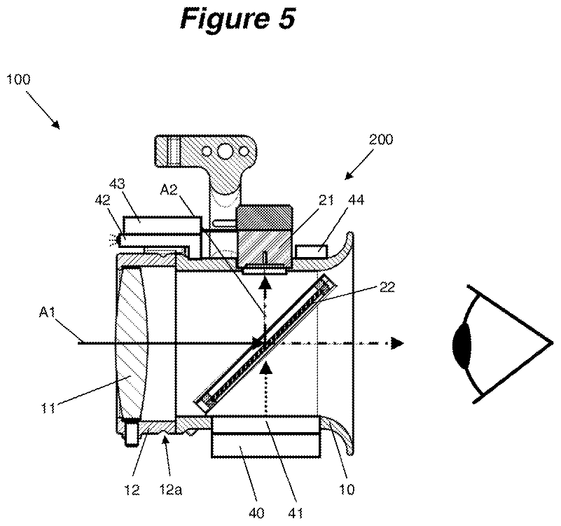

Images or information can then be projected directly towards the user's eye. These images or information can be superposed on the direct view of the user. To do so, as shown in FIG. 5, the projection element 40, 41 can include a screen 40 arranged on the periphery of the body 10 and the light emitted by said screen can be reflected towards the user's eye by the semi-transparent mirror 22. Advantageously, this screen 40 can be arranged coaxially with the axis A2 on the periphery of the body 10, on the other side of the sensor 21. Thus, the projection element 40, 41 for projecting visual data is arranged coaxially with the sensor 21 and opposite the sensor 21 relative to the body 10.

This arrangement enables the semi-transparent mirror 22 to be used to divert a portion of the light from the screen 40 towards the user's eye. The other portion of the light from the screen 40, which is not diverted by the semi-transparent mirror, is advantageously captured by the sensor 21. The sensor 21 thus captures a portion of the light passing through the optical system 11 as well as a portion of the light coming from the screen 40. In other words, the sensor 21 captures the same superposed images as the user's eye. Thus, the semi-transparent mirror 22 can be arranged such as to:
divert a first portion of the light rays emitted by the projection element 40, 41 towards the user's eye, and
allow a second portion of the light rays emitted by the projection element 40, 41 to pass through said mirror.

Given that the images projected by the screen 40 are diverted towards the user by the semi-transparent mirror 22, these images need to be inverted so that the user can see the images the right way round. Moreover, inverting the images projected by the screen 40 does not cause a problem with the sensor 21, since the images captured from the optical system 11 are also diverted and inverted by the semi-transparent mirror. The resulting superposed images from the optical system 11 and the screen 40 are therefore consistent.

A set of lenses 41 can also be arranged between the screen 40 and the user's eye to correct and/or adapt the image projected towards the user.

The screen can be arranged in any other manner enabling the user of the optical device to view the screen directly or indirectly.

The image projected towards the user's eye can undergo image processing, and even processing provided using artificial intelligence able to recognize the elements captured by the sensor 21. The screen 40 can thus for example be used to superpose the following onto the user's view:
elements used to highlight the observed elements,
assembly instructions,
quantities and locations of lubricants to be applied,
element references,
the rate variation, amplitude and beat error of a clock oscillator,
more generally, any image or information that may be of interest to the user and/or anyone looking at the images captured on an attached screen.

The optical device 100 can also include a lighting element 42, notably a lighting element arranged such as to illuminate or emit light. The lighting element firstly provides additional light for the user in zones that are for example difficult to access, and secondly advantageously provides more light for the sensor 21. Preferably, the lighting element 42 can be arranged on the body 10 and emit light towards the observed object or the observed scene, as shown in FIG. 5. The lighting element can be arranged coaxially with the body 10. The lighting element may also be annular and coaxial with the axis A1.

Alternatively, the lighting element 42 can also be arranged coaxially with the axis A2, on the same side as the sensor 21, emitting light towards the semi-transparent mirror 22. With this arrangement, the observed object is illuminated coaxially or substantially coaxially with the vision axis A1 by diverting the beams using the semi-transparent mirror 22. In the latter case, it is judicious to select a semi-transparent mirror 22 in which a large portion of the light is diverted towards the observed element.

The lighting element can also be asymmetrical and/or provide a range of light intensities. The lighting element can also comprise several light sources, and even offer several different types of illumination, with different wavelengths for example. The user can use an interface to select these different options as required.

The lighting element 42 can include a light source such as a light-emitting diode (LED) or OLED or optical fiber light guiding or light guide.

The lighting element 42 can also emit ultraviolet radiation to provide a better view of certain specific lubricants, using a suitable filter or otherwise.

The optical device 100 can also include a microphone 43 and a sound interpretation module 53, notably a module 51 for interpreting voice commands.

The module 51 for interpreting voice commands for example enables control of the capture device 200 and/or the communication element 50 and/or the projection element 40, 41 and/or the lighting element 42 and/or a module 52 for processing an audible signal to identify the rate variation of a movement making sounds that are picked up by the microphone 43. This enables certain functions of the optical device 100 to be controlled, such as activating and deactivating the sensor 21, adjusting the degree of magnification thereof, and controlling the display on the screen 40.

In particular, the sound interpretation module 53 can include a chronocomparator 52 to measure the rate variation, amplitude and beat error of a clockwork movement by interpreting the sounds made by an escapement device. The sound of certain elements in response to mechanical stressing can also be interpreted.

The microphone 43 also enables comments made by the user or sounds coming from the observed object to be picked up.

In the embodiment described, the optical device 100 is designed to be mounted on a support, such as eyeglass frames 300, in which the support and the optical device make up a portable system 500. The support and the optical device are then designed to position the optical device opposite or close to the user's eye.

However, in a variant, the optical device 100 can be designed to be held in the user's eye socket in the manner of a conventional watchmaker's loupe, in particular without a support 300, in particular without a frame. In such a case, as mentioned above, the body 10 is conformed at one of its ends so as to be positioned in contact with the user's face and so as to adapt to the morphology of the user's face.

In the embodiment shown in FIGS. 1 to 6, the portable device is designed to be worn by the user like a conventional pair of glasses, as shown in particular in FIGS. 1 and 2.

The frames 300 comprise a framework 30 and two temples 35 as well as first adjustment means 38 provided with a height-adjustable nose bridge 36 in order to adapt to the shape of the user's face.

Alternatively, the first adjustment means 38 for adjusting the height of the optical device 100 in relation to the user's eye can also be arranged elsewhere on the portable device 500, for example at an interface between the frames 300 and the optical device 100.

In this example, the temples 35 are assembled rigidly on the framework 30 using screws. Alternatively, the temples 35 can also be assembled with hinges, adjustable or otherwise, as on a conventional pair of glasses.

The frames 300 may also include support elements 37 to fasten the electronic elements of the optical device and/or to guide the data-transfer and power cables so that said cables do not inconvenience the user. These support elements 37 are for example arranged on the temples 35.

The eyeglass frames 300 include a fastening assembly 31, 32 arranged at the interface of the frames 300 and the optical device 100. This fastening assembly 31, 32 enables the body 10 to be linked to the framework 30. The fastening assembly includes first guided fastening means 31 clamped on the body 10, for example using two pins, a screw and a nut, as shown in FIG. 2. This arrangement includes second adjustment means 39 enabling the position of the body 10 to be adjusted in relation to the user's eye in a transverse direction corresponding to the direction of the framework 30.

Naturally, these first fastening means 31 may be fastened to the body 10 using any other means. Alternatively, these fastening means may be integral with the body 10.

Alternatively, the second adjustment means 39 for adjusting the transverse position of the optical device 100 in relation to the user's eye can also be arranged elsewhere on the portable device 500, for example on the framework 30 of the frames 300.

The first adjustment means 38 and the second adjustment means 39 advantageously form an adjustment assembly 38, 39 for precisely adjusting the position of the optical device 100 on the frames 300 in relation to the position of the user's eye.

The fastening assembly 31, 32 includes second fastening means 32 that are designed to fasten the first fastening means 31 using a pivot link. This pivot link is formed by a shaft 33 passing through the fastening assembly 31, 32 and fastened in the first or second fastening means 31, 32 to enable the first fastening means 31 to pivot in relation to the second fastening means 32.

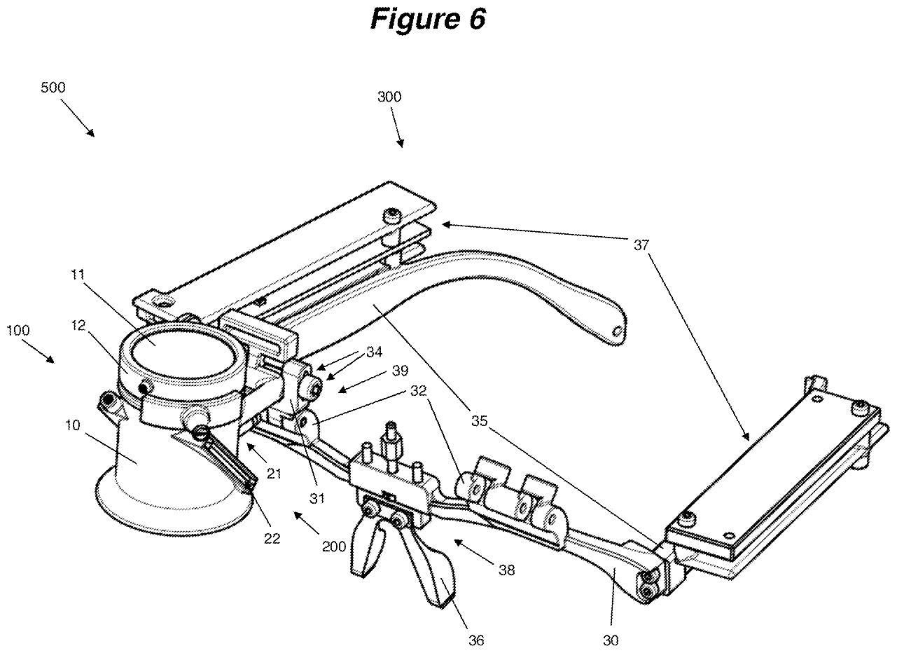

Furthermore, the second fastening means 32 also have two spring plungers 34 that are substantially identical to the ball plungers 13a described above. These two spring plungers 34 or ball plungers 34 are arranged radially in relation to the shaft 33 and are designed to cooperate with notches 31a arranged on the first fastening means 31. The arrangement of the ball plungers 34 inside these notches 31a, as well as the pivot link described above, advantageously make it possible to predefine two relatively stable positions, or two indexing positions, of the optical device 100 in relation to the frames 300. A first position (shown in FIG. 1), referred to as the working position, corresponds to the position of the optical device 100 when aligned with the user's eye. A second position (shown in FIG. 6), referred to as the retracted position, corresponds to a position retracted or partially retracted from the field of vision of the user.

Thus, the optical device 100 can advantageously be retracted upwards so as not to encroach upon the working space of the user. This also obviates the need for the user to remove the frames 300 from their head between successive operations or when the user does not require the optical device. This provides the user with functionality comparable to the functionality of a watchmaker's loupe arranged on a conventional headband or eyeglass frames.

Advantageously, second fastening means 32 can be arranged before the other eye of the user. The optical device 100 can then be fastened in front of the left or right eye.

Also advantageously, to increase comfort, the framework 30 can also include corrective lenses suited to the user's vision.

Finally, the whole of the frames 300 is built such as to unencumber the working space about the optical device 100 as much as possible, to give the user as much freedom as possible, as when using a conventional watchmaker's loupe. For this reason, the sensor 21 and the fastening assembly 31, 32 are preferably arranged on top of the optical device 100.

Alternatively, the support may be a headset or a headband similar to those already used by watchmakers.

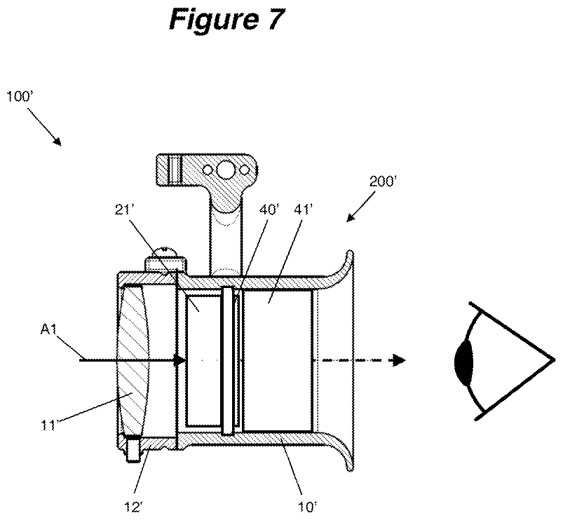

A second embodiment of a portable system is described below with reference to FIG. 7. This second embodiment differs in that it includes a second embodiment of an optical device 100′ as shown in FIG. 7.

The reference signs for the elements of the second embodiment can be deduced from the reference signs of the elements in the first embodiment having identical or substantially identical structures and/or identical or substantially identical functions, with an added apostrophe r.

Preferably, the second embodiment differs from the first embodiment only in that the optical device 100′ includes a capture device 200′ including a sensor 21′ arranged inside the body 10′.

Preferably, the optical device 100′ also includes a screen 40′, the sensor 21′ and the screen 40′ being arranged inside the body 10′, notably coaxially with the first optical axis A1.

Thus, as shown in FIG. 7, the user does not have a direct view through the optical device 100′ in this second embodiment. Indeed, observation is enabled exclusively via a screen 40′. However, this arrangement can provide the user with a view that is completely digitally processed and filtered. Suitable image processing therefore makes it possible to completely hide certain elements or reflections of light in order to increase user comfort, and/or obtain a greater depth of field than by direct viewing, and/or to automatically adjust the brightness and contrast of the image.

In this second embodiment, the sensor 21′ of the capture device 200′ is arranged inside the body 10′ along the axis A1. This sensor 21′ is provided to capture the light passing through an optical system 11′. The image captured by the sensor 21′ is broadcast by the screen 40′ also arranged in the body 10′ such as to project the image towards the user's eye along the axis A1. As in the first embodiment, a set of lenses 41′ can be arranged between the user's eye and the screen 40′ to correct and/or adapt the image projected towards the user's eye.

Unlike in the first embodiment, depending on the functionalities of the sensor 21′, the optical system 11′ need not be arranged inside the device. Indeed, the sensor 21′ can advantageously enable degrees of magnification of 2.5× to 25× and can potentially obviate the need for the optical system 11′.

Conversely, with the exception of these specific arrangements relating to this second embodiment, all of the functions and alternatives mentioned above in the first embodiment can be transposed to this second embodiment.

Preferably, regardless of the embodiment, the longitudinal size of the optical device (according to the axis A1), measured from the first to the second end of the body 10, is for example about a few centimeters, in particular about 4 cm (measured parallel to the optical axis A1).

Preferably, regardless of the embodiment, the optical device (without taking into account any means of securing for connecting the body to the support) is included in a cylinder having a radius of 1.8 cm or 2 cm or 2.5 cm around the optical axis A1.

Preferably, regardless of the embodiment, like a conventional watchmaker's loupe, the optical device is intended for operation at great proximity. To this end, the optical device is configured so that the distance (allowing to see clearly the object to be observed) between the lens and the object to be observed, is from about 8 cm to less than 1 cm, or even less than 0.5 cm, depending on the magnification of the lens.

For example, said distance is about 8 cm for a 2.5× lens, while for a high-magnification lens, for example 10× or more, said distance is about less than 1 cm or even less than 0.5 cm.

The most often used magnification is 4×. With this magnification, said distance is about 3-4 cm.

These distances are provided for an unaltered visual acuity of the user. It should be noted that this distance can vary significantly depending on the visual acuity of the user.

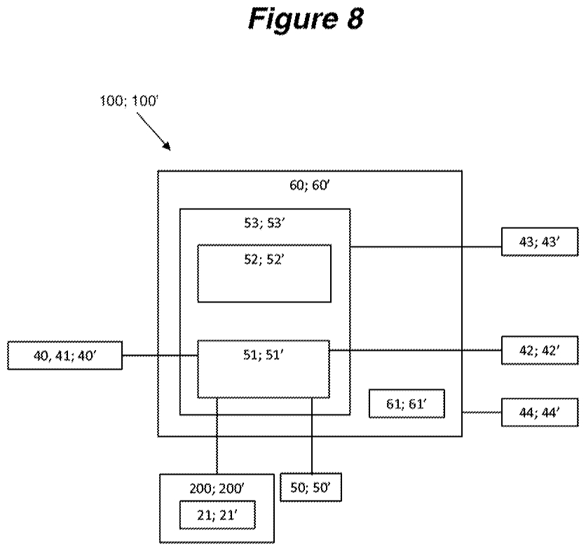

Regardless of the embodiment, and as shown in FIG. 8, the optical device 100; 100′ may include a logic processing unit 60; 60′ including:
a memory 61; 61′,
a sound interpretation module 53; 53′ including a module 51; 51′ for interpreting voice commands used to control the capture device 200; 200′ and/or the communication element 50 and/or the projection element 40, 41; 40′ and/or a lighting element 42; 42′ and/or a module for processing an audible signal 52; 52′, notably a chronocomparator 52; 52′ used to identify the rate variation of a movement making sounds that are picked up by a microphone 43; 43′.

Regardless of the embodiment, in order to display the rate variation, amplitude and beat error of a clock, the optical device 100; 100′, and more specifically the screen 40; 40′, may be coupled to a device designed to take this type of measurement. In this case, the optical device 100; 100′ may include a device such as a chronocomparator.

Regardless of the embodiment, the optical device 100; 100′ may also for example be coupled to a device able to take torque or force measurements, and to project the values of these measurements towards the user's eye using the screen 40; 40′.

Alternatively, a chronocomparator may also be coupled to the optical device. The sound is then communicated to the chronocomparator, then the values determined by the chronocomparator are projected to be seen by the user.

Being able to provide the user with measured values in real time advantageously enables the user to consult these values without having to look away from the object viewed through the optical device.

Regardless of the embodiment, the optical device 100; 100′ may also include a human-machine interface 44; 44′ with buttons or keys, for example push buttons, to control the functions of the optical device. The pushbutton of the interface 44; 44′ may be capacitive or otherwise.

Regardless of the embodiment, the data collected can enable images to be displayed on an attached screen to view the images broadcast and/or recorded by the optical device 100; 100′. This screen may be a television, a computer monitor, a smart phone screen, a digital tablet screen, or any other digital media that can be used to display images and/or video. The same applies to digital data provided by the optical device 100; 100′ that can be used or stored on any digital medium able to read this data, such as a memory card, a computer, a smart phone, a digital tablet, or any other digital medium able to use or store digital data.

Regardless of the embodiment, the portable system may include two optical devices 100; 100′ arranged such that each faces one of the user's eyes. This enables three-dimensional image capture.

Preferably, regardless of the embodiment, the capture device 200, 200′ is mounted directly on the body 10 or mechanically fixed to the body 10. The capture device 200 can in particular be mounted or fixed on the body 10 outside of the body. The capture device 200′ can in particular be mounted or fixed inside the body 10′.

Using the objects described above, it is possible to provide optical solutions that enable a small object to be observed with magnification while sharing the user's vision axis and allowing the user to get as close to the object as required. The solutions described above are small and enable the user to examine and work on objects in the manner of a watchmaker on a workbench. This makes it easier to share information and know-how.

To arrive at these solutions, an optical device is provided with a camera that is able to share the vision axis of the watchmaker on a screen, while affording the watchmaker the same degree of operational freedom as with a conventional watchmaker's loupe.

According to the solutions described, a capture device is arranged inside an optical device, and more specifically inside a watchmaker's loupe. Advantageously, the optical device is provided with a camera that shares the vision axis of the watchmaker or the user through the optical device.

This enables the view shared on an attached screen to be as close as possible to the actual view of the watchmaker or the user, without this latter being inconvenienced by the capture device or having to change working practices to adapt to a viewing instrument such as binocular magnifiers.

Also advantageously, in the solutions described, a lens can be interchanged rapidly and easily with other lenses having different focal lengths for example without the need for tools, or even without having to withdraw the optical device from the user's vision axis.

As an alternative to the feature of capturing at least a portion of the images seen by the user through the optical device, although less favorable for sharing the vision axis, especially in areas that are difficult to access, a capture device can be mounted or fixed on the body (outside of the body) in order to capture, in direct vision, images of the observed object. The parallax effects of the captured images can be corrected by adequate digital processing.

In this document, “user” means any person using the portable system or optical device. The user can notably be a watchmaker or a salesperson.

1. An optical device,
wherein the optical device is a monocular watchmaker's loupe that can be positioned or worn in front of or close to a user's eye, and
wherein the optical device comprises:
a first optical axis,
an optical device body, notably a substantially cylindrical body, and
a capture device for capturing at least a portion of the images seen by the user through the optical device.

2. The device as claimed in claim 1, characterized in that the capture device includes a sensor arranged on the outer periphery of the body, notably above the body when the optical device is positioned in front of the user's eye for use.

3. The device as claimed in claim 1, characterized in that the optical device includes a semi-transparent mirror arranged inside the body such as to:
divert a first portion of the light rays entering the optical device towards the sensor, and
allow a second portion of the light rays entering the optical device to pass through said mirror to the user's eye.

4. The device as claimed in claim 2, characterized in that the sensor has a second optical axis perpendicular to the first optical axis.

5. The device as claimed in claim 1, characterized in that the capture device includes a sensor arranged inside the body.

6. The device as claimed in claim 5, characterized in that the optical device includes a screen, the sensor and the screen being arranged inside the body, notably coaxially with the first optical axis.

7. The device as claimed in claim 1, characterized in that the optical device includes a communication element that is designed to send data generated by the capture device and/or to send data to the capture device.

8. The device as claimed in claim 1, characterized in that the optical device includes an optical system, notably at least one lens, held on the body by retaining means.

9. The device as claimed in claim 8, characterized in that the retaining means are friction, snap-fit or obstacle retaining means, notably retaining means arranged such as to enable an optical system to be positioned and/or mounted without using tools.

10. The device as claimed in claim 1, characterized in that the optical device includes a projection element for projecting visual data visible by the user by displaying on a screen that is part of the optical device and/or by projecting light rays towards the user's eye.

11. The device as claimed in claim 2, characterized in that the projection element for projecting visual data is arranged coaxially with the sensor and opposite the sensor relative to the body.

12. The device as claimed in claim 3, characterized in that the semi-transparent mirror is arranged such as to:
divert a first portion of the light rays emitted by the projection element towards the user's eye, and
allow a second portion of the light rays emitted by the projection element to pass through said mirror.

13. The device as claimed in claim 1, characterized in that the optical device includes a lighting element, notably a lighting element arranged such as to illuminate coaxially with the body.

14. The device as claimed in claim 1, characterized in that the optical device includes a microphone and a sound interpretation module, notably a module for interpreting voice commands used to control the capture device and/or the communication element and/or the projection element and/or the lighting element and/or a module for processing an audible signal used to identify the rate variation of a movement making sounds that are picked up by the microphone.

15. A portable system including an optical device as claimed in claim 1 and a support, notably a headset or eyeglass frames or a headband, on which the body of the optical device is mounted.

16. The portable system as claimed in claim 15, characterized in that the portable system and more specifically the support, includes:
an adjustment element arranged such as to position the optical device relative to the user's eye, and/or
a fastening assembly arranged such as to enable the optical device to be removed from the user's eye.
